(19) United States
(12) Patent Application Publication
(10) Pub. No.: US 2022/0274204 A1
(43) Pub. Date: Sep. 1, 2022

(54) Method For Creating An Iridescent Visual Effect On The Surface Of A Material, Devices For Carrying Out Said Method, And Part Obtained Thereby

(71) Applicant: APERAM, Luxembourg (LU)

(72) Inventors: Ismaël Guillotte, Verquin (FR); Baptiste Latouche, Lille (FR); Marcos Vinicius Lopes, Bethune (FR); Jean-Michel Damasse, Saint Etienne (FR); Francis Diet, Paris (FR)

(21) Appl. No.: 17/604,077

(22) PCT Filed: Apr. 16, 2019
(86) PCT No.: PCT/IB2019/053122

§ 371 Date: May 12, 2022

(51) Int. Cl. B23K 26/352; B23K 26/0622; B23K 26/082; B23K 26/04; G02B 27/28; G02B 5/30

(52) U.S. Cl. CPC B23K 26/352; B23K 26/0624; B23K 26/082; B23K 26/048; G02B 27/286; G02B 5/3025; B23K 2101/18

(57) ABSTRACT

Method for creating an iridescent visual effect on the surface of a part, using a laser beam having a pulse duration of less than a nanosecond sent onto said surface in the optical field of the focusing system of a device comprising also a laser source and a scanner, to apply wavelets having the same orientation to said surface over the pulse width. The scanner scans the surface using laser radiation along a series of consecutive lines, or a matrix of points using relative movement of said surface and the device, the width of each line or the dimension of each point of each matrix being equal to the pulse diameter. Between the carrying out of the scanning along two consecutive lines or two adjacent points the polarization of the laser beam is modified to create wavelets having different orientations on two consecutive lines or two adjacent points.

The present invention relates to the laser treatment of the surfaces of stainless-steel sheets or other materials, intended to give these surfaces an iridescent effect.

Iridescent treatment, also called “LIPPS” or “wavelets”, consists in irradiating the surface of a material with a pulsed laser radiation of short pulse duration (less than one nanosecond). The diameter of each pulse at its impact point on the material to be treated is typically of the order of 10 to a few hundred μm. If the energy of the incident beam is sufficiently high, this irradiation induces the modification of the structure and/or the reorganization of the material surface which will adopt a periodic structure. However, if the beam energy is too high, a phenomenon of ablation by vaporization/sublimation/shockwave can take place, preferentially or jointly with the formation of the periodic surface structure. It is easy to determine experimentally what range of energy is to be used for a given material, in order to obtain the desired iridescence effect with or without alteration of the surface condition or gloss.

Such treatment is practiced, in particular, but not only, on stainless steels of all types. The purpose of this treatment can be purely aesthetic, but it also allows the wettability of the surface to be modified, and also its resistance to friction and bacterial adherence to be reduced. The treatment can be done directly on the surface of the object on which the stainless-steel passivation layer is located without the need for prior activation/depassivation.

Other materials on which this treatment is carried out are various metals, polymers such as PVC, ceramics, glass, in particular.

In the following, the case of stainless steels will be favored, with it understood that the invention is applicable to all metallic or non-metallic materials that are currently or would in the future be known, to be able to present an iridescent effect following a laser treatment carried out as indicated, possibly by adapting the precise operating parameters of the facility (power and frequency of the lasers etc.) that are known to play a role in obtaining the iridescent effect resulting from the formation of a periodic surface structure.

Although the exact formation mechanism of this periodic surface structure is not yet determined, tests and characterizations carried out by various laboratories show that according to the number of laser passes and/or the pulse energy and/or the scanning parameters, the structure of the surface can present one of the four following structures, according to the total irradiation energy per unit of surface, with these structures being classified in increasing energy order and the naming thereof usually being used by persons skilled in the art even non-English speaking persons:

1) Structure Known as “HSFL” (High Spatial Frequency LIPPS):

This structure is composed of small wavelets that, in the case of stainless steels, are oriented in the direction of the polarization of the incident laser beam. The spatial frequency of these wavelets is lower than the laser wavelength used for the treatment.

2) Structure Known as “LSFL” (Low Spatial Frequency LIPPS):

This structure is composed of wavelets larger than the previous ones, oriented in the direction perpendicular to the polarization of the incident beam, in the case of stainless steels. The spatial frequency of these wavelets is slightly lower, or higher, or equal to the laser wavelength. For the treatment of a stainless-steel surface with a laser wavelength of 1064 nm, the periodicity of the wavelets is of the order of 1 μm. It is still possible to see the HSFL structure in the hollows of the LSFL structure.

It should be noted that the respective orientations of the HSFL and LSFL structures can be reversed for some materials, compared to what they are for stainless steels.

3) Structure Known as “Grooves” or “Bumps”:

This structure is composed of bumps of micrometric dimensions covering the entire treated surface. These bumps are organized in a structure similar to a “snake skin” effect.

4) Structure of Peaks or “Spikes”:

This structure is composed of spikes whose height ranges from a few micrometers to a few tens of micrometers. The distance between the spikes depends on the treatment parameters.

More details on these structures and the mechanism of their effect can be found in the article “Evolution of nano-wavelets on stainless steel irradiated by picosecond laser pulses”, Journal of Laser Applications, Feb. 26, 2014, by B. Liu et al. In particular, it is stated that, for an equal number of pulses, an increase in the fluence of the irradiation leads to obtain HSFLs rather than LSFLs (as just mentioned), while for an equal fluence, a higher number of pulses leads to the creation of LSFLs rather than HSFLs, until the number of pulses becomes too high for wavelets to be observed. The exact configuration of the surface after irradiation, for a given material, is thus the result of a mechanism involving both the number of pulses received and the energy delivered by each of them. This mechanism is complex, but for a given material, reliable conditions for obtaining one or the other of the configurations mentioned above can be determined experimentally by the user.

In general, in the first two cases, this periodic organization of the surface allows an induced phenomenon, well known to operators of laser surface treatments, which is the diffraction of light through the creation of an optical network when the treated sample is placed under a light source. As a function of the orientations and positions of the user, and of light, the colors of the rainbow can be seen on the sample. This is known as an “iridescent effect”.

This effect no longer exists when the surface of the sample has a pronounced effect of the third or fourth above-cited cases, since in these two cases the energy delivered by the laser source onto the surface of the sample has reached a level that is too high at least locally, causing surface deformations which no longer allow obtaining of the iridescent effect, since the surface structuring has lost its periodic nature.

This iridizing is not to be confused with the surface coloring of stainless steels which are obtained, whether or not voluntarily, by plasma treatments or surface oxidations obtained by furnace or torch treatments. The iridescent effect does not result from coloring, but from the effect of colors on the surface under certain conditions of observation. The absence of periodicity of surface structure in coloring processes properly co-called is an essential difference between surface iridizing according to the present invention and the coloring of stainless steel via plasma, furnace or torch treatments.

However, the observation of such iridescence is highly directional, i.e., the observation of this iridescence and the intensity of the observed iridescence is highly dependent on the angle at which the material surface is observed.

Another problem facing practitioners of surface iridescence is the following.

It is currently possible to obtain homogeneous samples in the laboratory with an iridizing treatment using either solely a system coupling together a laser and a scanner producing both a rapid travel axis of the laser beam (via a polygonal wheel or galvanometer mirror) and a slow travel axis of the laser beam (via a galvo mirror), or a laser and scanner system coupled with a robotic arm moving the scanner along the slow axis.

Movement the scanner along the slow axis can be replaced by movement of the sheet to be treated, in front of a laser which remains fixed on the slow axis. Provision can also be made so that the laser remains fixed along both axes (slow and fast), and that it is the object to be treated which is moved along the two axes.

The formation mechanism of the structures just described is dependent on the total energy transferred onto the surface of the material and on the spatial and temporal distribution of this energy. Thus, the “intensity” of the iridization obtained with LSFLs will increase between each new pass of the laser on the areas already treated, up until a maximum is reached, after which it will decrease when the LSFLs will gradually become “bumps” under the effect of the additional applied energy.

This means that there exists an energy optimum to be transferred onto the surface of the material, an optimum for which the iridescent effect is the most intense, this optimum to be determined and applied to all the surface under consideration.

However, these samples are generally of small size and/or obtained with low productivity.

The limitation in size of the samples is mainly due to the limitation of the dimensions of the optical fields of the assemblies formed by the laser, scanner and focusing system, latter possibly being for example a lens or a convergent mirror. Indeed, obtaining a homogeneous treatment requires a perfect control over the treatment at every point of the surface. Yet, irrespective of the focusing systems used, they all have an optical field on which they have a stable effect within an optimal area, but as soon as one leaves this optimal area, the system induces distortions and/or attenuations of the power of the laser beam, which result in a non-homogeneous treatment between the optimal area of the optical field and the zones lying beyond this optimal zone.

Thus, to treat large areas of stainless-steel sheets, wide-field focusing systems are required, which would be very expensive and very sensitive. In addition, they would have to be used jointly with lasers of ultrashort pulse duration and of high power, these not yet widely available on the market.

To overcome this double disadvantage, known solutions are to use conventional focusing systems and lasers currently available on the market and either to place several devices including these focusing and laser systems side by side, in the case of an in-line treatment of a moving strip, or to perform the treatment several times (by cutting the surface into strips for a discontinuous system), or to combine these two solutions. However, this solution requires particularly careful management of the junction zones between the optical fields of two consecutive devices, which, if ill-managed, can cause a phenomenon known as “stitching” those skilled in the art, which will be described below.

This mechanism therefore prevents the use of a significant overlap of fields to join two consecutive fields of laser treatment.

Indeed, if there is a significant overlapping of the fields, in the order of magnitude of the resolution of the human eye, this would mean that the overlapping zone receives twice the amount of energy transferred onto the remainder of the surface. This doubling of energy injected at the time of treatment causes local change in the structure and hence in the surface effect compared with the areas that only received the nominal amount of energy of the treatment, and this change is visible to the naked eye. This phenomenon is commonly called “stitching”, in that it makes the junction area between two fields visible.

Conversely, a spacing between the laser treatment fields, which would make it possible to prevent this phenomenon of local doubling of the treatment and the resulting “stitching”, would imply the formation of an untreated zone, or less treated than normal, between the two fields. This zone would also be visible to the naked eye.

A near-perfect junction is therefore needed between consecutive laser treatment fields.

In contrast, performing this type of high productivity treatment implies working at high frequency (from hundreds of kHz). The scanning systems used for this type of treatment are most typically scanners having at least one polygonal wheel. At high frequencies, these systems generally exhibit synchronization problems between the laser electronics and the scanner electronics. These synchronization deviations lead to a shift in the position of the first pulse of the line in relation to its target position, and hence of the entire line. Even though this deviation is predictable and calculable (since resulting from the difference in the management frequencies of the two devices), it is encountered in most current systems and can represent a deviation of a few tens of micrometers between the start of the treatment lines (lines due to movement of the polygonal wheel). This gap is a function of the rotation speed of the polygon and the laser's own frequency, and experience has shown that an overlap of the fields with such difference is sufficient enough to enable the zone, in which treatment has been doubled, to impact the iridescent effect of the metal sheet.

Some systems under development have an internal means of partially correcting this offset by the action of an additional deflecting mirror, called a “galvo”, operating like a galvanometer, located upstream of the polygon. For example, the RAYLASE company presented the concept of such a system at the SLT 2018 congress in Stuttgart on 5 and 6 June, 2018: “New Generation of High-Speed Polygon-Driven 2D Deflection Units and Controller for High-Power and High-Rep. Rate Applications” (presentation by E. Wagner, M. Weber and L. Bellini). But the improvement alone is not of sufficient quality to ensure that the undesirable effects of a field shift disappear. Indeed, the initial and ed parts of each line may not be treated with the same delivered energy as the rest of the line. To solve this local treatment deficit, increasing the energy input on the rest of the line can be imagined, but this would then risk exceeding the maximum energy input adapted for creation of LSFLs, thus reducing or even suppressing iridization. The use of a galvo mirror upstream of the polygon can alleviate this problem, but this material is still at the experimental stage and, if commercially successful, it will necessarily be more complex and more expensive than what exists. For all the other systems, this lack of synchronization implies a need for a “virtual” overlap of the order of at least twice the dispersion of the positions of the line starts between the different optical fields. Thus, this overlap translates as a heterogeneous strip in which there are no nontreated zones between fields, but in which there may be an overlap of twice this dispersion at some points.

If the edges of each field are defined as “straight”, then the overlapping area appears as a thin straight strip, substantially equal in width to the width of the treatment lines, thus substantially equal to twice the diameter of the pulse, on which the treatment effect is not identical to the rest of the surface. Similarly, if the edges of the treatment field are defined by a periodic pattern, the latter will remain visible to the naked eye.

Several strategies are then possible to try to attenuate or mask the heterogeneity of the overlapping area.

The first strategy is to use a random offset between two consecutive lines perpendicular to the scanning direction of the scanner, so that the junctions between the optical fields of two consecutive lines, taken together, do not form a linear or periodic pattern, and thus this pattern is less visible than if it were a substantially straight line or a periodic pattern. The object is to achieve a treatment whose defects are easily detected by the human eye, which readily spots what is periodic and/or linear. In this case, if it is considered that the optimal treatment of the surface of the sheet 1 requires N passes, the random offset of the N series of superimposed lines is identical from one pass to another and from one field to another

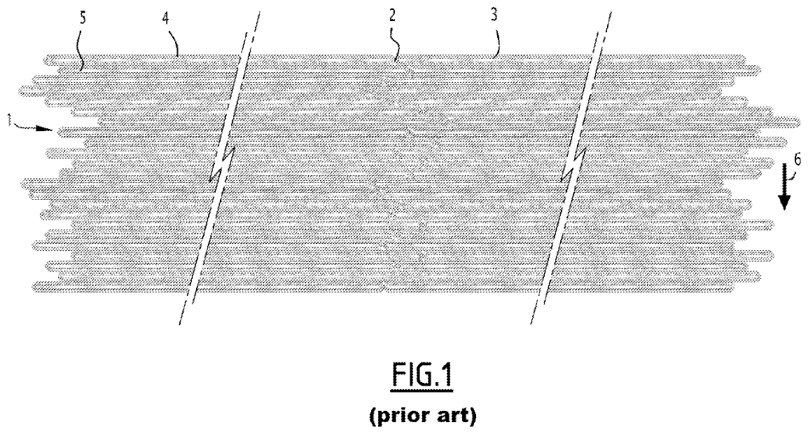

FIG. 1 shows such a configuration performed on a sheet 1. It can be seen there that, for series of two passes (scan lines) by the scanner corresponding to two consecutive fields located in the continuation of each other, the junctions 2 of the respective optical fields of the two series 3, 4 of the lines are shifted in a non-linear way. In other words, the respective junctions 2 of the lines 3, 4 do not form a straight line or a periodic pattern between them, but a broken line that is less easily discernible than a straight line. Some periodicity of the offsets between consecutive junctions 2 may be acceptable, but the period must extend over a sufficient length (typically at least 10 times the maximum value of the offset between two junctions 2 of two consecutive lines 4, 5 along the direction of advance 6 of the scanners) so that the pattern of this periodicity is not visible.

It is to be noted that between two consecutive lines 4, 5 formed in the same optical field and hence offset in the direction of travel 6 of the scanners (or in the direction of travel of the sheet 1, if it is the sheet that is mobile in this direction whereas the scanners are fixed), this problem does not generally arise with the same intensity unless the overlap between the lines is clearly poor. Indeed, as pointed out, the different lines 3, 4, 5 have widths that are substantially equal to the diameter of the pulse, i.e. about 30-40 μm in general. This diameter depends on the lens and the diameter of the laser beam entering the lens. To ensure that there are no untreated areas on the surface of the sheet between two consecutive lines 4, 5 along the slow axis, it is possible to adjust the scanner's galvo and/or the sheet travel device so that two consecutive lines 4, 5 overlap. In other words, the lines 4, 5 are formed after an offsetting of the relative positions of the pulses of each scanner and the sheet 1 that is slightly smaller than the diameter of the pulses. Thus, double treatment of the surface of sheet 1 in the overlapping areas of lines 4, 5 may indeed occur, but since the offset of lines 4, 5 can be controlled with good accuracy, much more accurately than the overlap of juxtaposed optical fields, the width of these areas when present is in any case sufficiently narrow that the double treatment does not visually translate as disturbance of the iridescent effect in relation to the effect obtained on the remainder of the surface of the sheet 1.

It is to be understood that, in FIG. 1, each series of lines 3, 4 located in the continuation of each other and meeting at the junction 2 is itself composed of the superposition of N superimposed lines, with N=3 for example. The number of superimposed lines for a given optical field is dependent on the quantity of energy to be transferred to the surface of the sheet 1 to obtain the desired wavelet configuration responsible for the surface iridescent effect. The higher this quantity, the higher the number of lines for the same energy supplied by each laser pass.

Inasmuch as possible, this configuration exhibits a structure of the LSFL type, which, as we have seen, is more able to provide this iridescent effect under conditions which are nevertheless dependent on the angle of viewing. The energy supplied along a given line must therefore be contained between a lower limit, below which the wavelets would not be sufficiently marked, and an upper limit, above which the probability of excessive presence of bumps is strongly increased. These limits are clearly highly dependent on multiple factors, in particular the precise material of the sheet 1, its surface condition, the energy brought by the pulses delivered by the pulses at each laser pass on a given zone . . . . Routine experimentation will enable those skilled in the art to define these limits as a function of available equipment and the material to be treated.

Although this first approach allows a substantial reduction in the visibility of the overlap of two consecutive fields, as a function of the material used and/or the targeted effect, since the overlaps between fields are not arranged in a straight line, but in a broken line, which follows the shifts between the overlaps, it can, however, prove to be insufficient to obtain a sufficiently homogeneous surface. In this case, it is possible to use the same approach, but changing the offset between the different laser passes. This makes it possible to further increase the random nature of the positioning pattern of overlaps compared with the preceding case. In other words, the broken line joining the consecutive overlaps and forming said pattern has an even less obvious non-periodic or random character. But it is still necessary to ensure that the juxtaposed treatment fields have the same offsets as the first, for each pass, since local accumulation of laser passes must be avoided to obtain treatment of homogeneous effect, in the same manner as ideally every point of the surface should receive the same amount of energy according to the same distribution, the same number of pulses and passes.

The use of a random field edge pattern therefore allows the distribution of the heterogeneity points without them forming a straight line that would be too visible to the naked eye. When the pattern they draw is identical for all passes, these points are locations where heterogeneity is strong, because the discontinuity of the line is marked at each pass.

However, when this pattern is different for each pass (whether random or not), although the number of heterogeneity points is multiplied by the number of passes N, these points have less pronounced heterogeneity compared to the rest of the surface than in the previous case, because they have received N−1 continuous passes and only one discontinuous pass.

This second approach allows an efficient masking of the junction area of the treatment fields. However, it requires a rigorous control of the positions of the treatment fields in relation to each other, both in the direction of the laser lines (so that there is no overlap or untreated area) and in the transverse direction (if the fields are shifted, the junctions will no longer be exact and this could lead to the formation of under-treated or, on the contrary, over-treated areas. Moreover, depending on the parameters chosen, it is sometimes possible to perceive the lines or the periodicity of the treatment lines on the surface. A shift in altitude of these lines between juxtaposed fields tends to amplify the visibility of the junction because of the phase shift between the lines.

Performing the treatment in the form of lines allows advantage to be taken of the high repetition frequency of the ultra-short pulse duration lasers to increase the productivity of treatment. Thus, in a single scan of the line by the scanner, the line could be irradiated N times if the distance between two consecutive pulses is equal to the diameter of the pulse over N. This thus allows erasing of the effect that small power fluctuations could have on the surface homogeneity.

However, this mode of action has the disadvantage of forming zones of heterogeneity at the line ends the over distances equivalent to the diameter of a pulse (a few tens of micrometers).

To avoid this, a possible solution would be to carry out the treatment by making the pulses draw a pattern in the form not of lines, but of a matrix of points, said points being comparable to pixels, and by carrying out as many matrices as necessary so that the surface of the sheet is entirely covered, at the end of the treatment, by the impacts of the pulses which overlap only very slightly or not at all. Thus, the junction of the different fields (and of the different pulses of each field) does not form a continuous pattern of relatively large dimensions, and is, in principle, no longer visible. Each point has a shape and dimension (for example circular for a Gaussian laser) comparable to that of the pulse.

However, the point approach is not yet possible with high productivity because of the synchronization problems between the laser and the scanner mentioned above. Indeed, for this approach to be valid and to provide a treatment with a homogeneous final effect, the laser must irradiate precisely the same area (the same point) each time in order to have the cumulative effect necessary to form the same intensity level of the LSFL structure at each point. However, this lack of synchronization leads to a random shift that can be of similar dimensions to those of the pulse, and it is not possible to achieve the accuracy required for the irradiation.

This problem could be partially solved by the use of the new generation of scanners, which have an additional galvo for the correction and/or anticipation of this offset which would be due to the bad synchronization. In this case, the accuracy of the juxtaposition of two fields would also be improved, as well as the overall homogeneity of the surface. However, the productivity of the method would remain unsatisfactory for treatment of large surface parts.

Moreover, the principle of spot treatment is not, in itself, capable of resolving the problem of the impossibility of observing the iridescence from all desired viewing angles.

It is the objective of the invention to propose a laser method with ultrashort pulses for treating a surface of a product such as stainless-steel sheet, but not limited thereto, allowing an iridescence to be conferred on it, appearing homogeneous following treatment, according to at least most, and preferably all, angles of observation, even if this iridescence is obtained by means of a plurality of juxtaposed fields.

Also, in the case of a treatment by lines, this method should optimally lead to allowing the junction zone of several consecutive optical fields to be made invisible to the naked eye, the fields being arranged so that together they allow the treatment of a larger surface portion (typically the entirety thereof) than would be possible with a single optical field. This method would have to have good productivity, to be applicable to the treatment of large surface products.

For this purpose, the subject of the invention is a method for creating an iridescent visual effect on the surface of a part, whereby laser beams having a pulse duration of less than one nanosecond are projected onto said surface in the optical field of the focusing system of a device comprising a laser source, a scanner and said focusing system, so as to apply a structure in the form of wavelets, having the same orientation to said surface, over the width of said pulse, and said surface is scanned by said scanner(s) with said laser beams along a series of consecutive lines, or a matrix of points, the width of each line or the dimension of each point of each matrix being equal to the diameter of said pulse, by means of a relative travel of said surface and of the device emitting said laser beam, characterized in that, between preforming the scanning along two consecutive lines or two contiguous points, the polarization of the laser beam is modified in such a way as to create wavelets of different orientations on two consecutive lines or two contiguous points.

Polarization of the laser beam can be modified according to a periodic pattern, said periodic pattern extending over M consecutive lines, M being equal to at least 2, preferably at least 3.

Two consecutive or adjacent points preferably have angles of polarization that differ by at least 20° and at most 90°.

A laser beam with a pulse duration of less than one nanosecond can be directed onto said surface in the optical field of the focusing system of a first device comprising a laser source, a scanner and said focusing system, and a laser beam with a pulse duration of less than one nanosecond can be directed onto said surface in the optical field of the focusing system of at least one second device comprising a laser source, a scanner and said focusing system, with the polarizations of two lines located at the extension of each other, or of two adjacent points, belonging to two adjacent fields, being identical.

Said relative travel of said surface of said part and of the device(s) emitting said laser beam(s) can be achieved by placing said part on a mobile support.

Said relative travel of said surface of said part and the device(s) emitting said laser beam(s) can be achieved by placing the device(s) emitting said laser beam(s) on a mobile support.

Said part can be a sheet metal.

Said surface of said part can be three-dimensional

Said part can be made of a stainless steel.

The invention also relates to a unit device for imparting an iridescent effect on the surface of a part by the formation of wavelets on said surface by the pulse of a laser beam, comprising a laser source generating a laser beam of pulse duration shorter than 1 ns, a beam-forming optical system, a scanner allowing the beam pulse, after passing through a focusing system, to line scan an optical field on the surface of the part and means for creating a relative movement between said device and said part to perform the treatment on at least one portion of the surface of said part, characterized in that said optical system comprises a polarization optical system that confers a determined polarization on said beam, and means for varying this polarization so that, on said surface, two lines or two contiguous points are produced with pulses of different polarizations.

Preferably, said device can allow two contiguous lines to be obtained with pulses having polarization differing by at least 20°.

Said device may comprise means for measuring the distance between the focusing system and the surface of the part, connected to control means of the focusing system, so that the latter maintains a constant pulse diameter and constant fluence on said surface, irrespective of said distance.

Said means for creating relative movement between said device and said part may include a movable support for the part.

The invention also relates to a device for imposing an iridescent effect on the surface of a part by the formation of wavelets on said surface by the pulse of a laser beam, characterized in that it comprises at least two unit devices of the preceding type, the optical fields of whose focusing systems overlap.

Said means for creating a relative movement between said device and said part may comprise a movable support for said unit device(s).

The invention also relates to a part made of a material whose surface iridescence is provided by means of laser treatment, said treatment having formed wavelets on the surface of said part, characterized in that said wavelets have at least two orientations, preferably at least three orientations, distributed over the surface of said part, preferably in a periodic pattern.

As will have been understood, the invention consists in eliminating, or at least very greatly attenuating problems related to the excessive directionality of viewing the the surface iridization of stainless steel treated by a device comprising a laser scanner, by applying different polarization of the light emitted by the laser for the formation of the LIPPS of two consecutive lines, or of contiguous points of two dot matrices, formed by the scanning of the laser beam according to the optical field of the focusing lens of the device. The use of at least three different polarizations, for a series of at least three consecutive lines, or three dot arrays, is recommended to obtain the desired effect.

This method can also be used in conjunction with a method intended to render invisible or almost invisible the junctions between two lines facing each other and produced by the juxtaposition of two laser scanner devices whose fields slightly overlap to avoid the risk of non-treatment or under-treatment of these junction zones.

It should be noted that the invention is applicable, in its basic principle, to both line laser treatments and laser point treatments, or to a treatment that combines both modes. Of course, one can choose to limit the treatment to a part of the surface of the object (for which a single laser and its optical field could possibly be sufficient), or to carry out the treatment on the entire surface of the object. To do this, it is sufficient to adapt the number and extent of the optical field(s) of the focusing lens(es) of the laser device(s) and the extent of the relative travels between the treatment device and the object to be treated, so that it is possible to treat the entire surface concerned.

The invention will be better understood on reading the following description given with reference to following appended Figures:

FIG. 1, which shows, as mentioned in the introduction, the surface of a metal sheet on which an iridescent laser treatment has been carried out by a method according to the known prior art, by means of two contiguous laser devices of a known type, randomly forming lines located in the extension of each other with overlapping areas between two lines generated in the respective optical fields of the two devices, with the object of reducing the visibility of the overlapping areas of said lines;

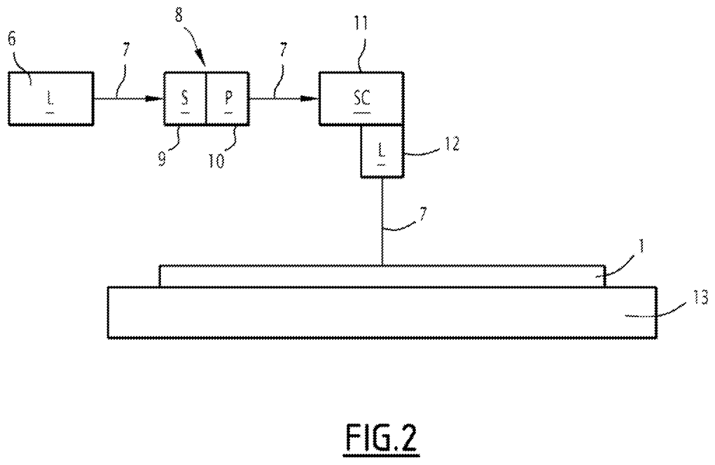

FIG. 2, which shows the schematic diagram of a device according to the invention, allowing implementation of the method of the invention in the optical field of a laser treatment device, with the object of allowing observation of surface iridization of the metal sheet independently of observation angle;

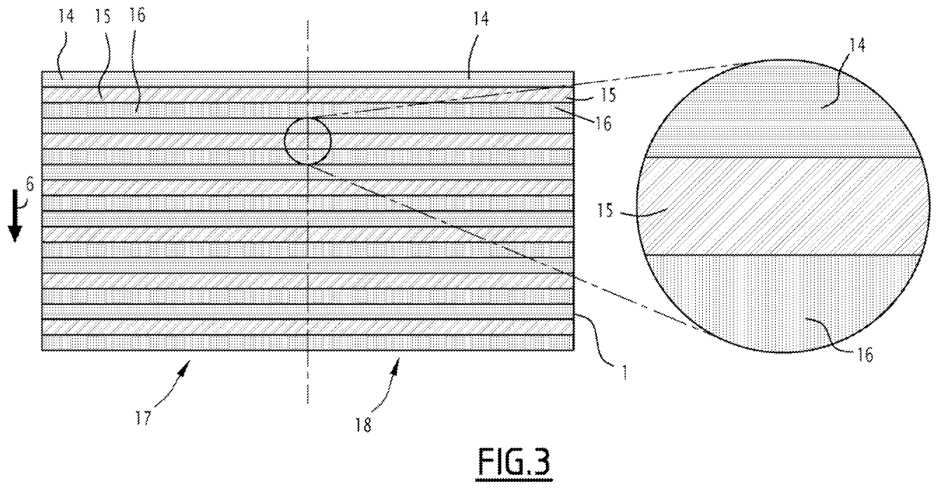

FIG. 3, which shows the surface of a metal sheet resulting from implementation of a method improving the method used in the case of FIG. 1 by two contiguous laser treatment devices, and whose use may be cumulative with that of the method according to the invention.

As indicated, the iridescent effect obtained by treatment with an ultrashort pulse laser is related to the spontaneous formation on the surface of a periodic structure having a behavior similar to an optical network on surface-reflected light. As previously discussed, the formation mechanism of this wavelet structure distributed periodically over the treated surface has not yet been established by the scientific community.

However, it has been shown (see, for example, the paper “Control Parameters In Pattern Formation Upon Femtosecond Laser Ablation”, Olga Varlamova et al, Applied Surface Science 253 (2007) pp. 7932-7936), that the orientation of wavelets is chiefly related to the polarization of the laser beam irradiating the surface. Thus, the orientation of HSFLs is parallel to the polarization of the incident beam whereas LSFLs, which are subsequently formed when a greater amount of energy is delivered to the sheet surface, are oriented perpendicular to polarization of the incident beam.

For laser treatment by lines, it thus results that a surface treated without modification of polarization of the laser beam throughout the different passes thereof on a given line of said surface, would therefore result at the end of treatment in a structure composed of lines/wavelets all oriented in the same direction. This means that the “optical network” effect of the surface is also oriented.

Indeed, iridescent effect appears maximal if observation is made in transverse direction to the orientation of the wavelets and decreases as and when the orientation angle of observation aligns with the structure of the surface. Therefore, observation of the surface in the alignment of the wavelets does not cause any color to appear. This can be a disadvantage for the end product because the orientation of the wavelets must be chosen carefully at the start of treatment in order to obtain a product having the iridescent effect under the desired viewing conditions. Moreover, the end product only appears fully colored in one main viewing direction.

The invention makes it possible to avert this disadvantage, because the device used makes it possible to obtain a surface for which the iridescent effect is visible in an identical way in all directions of observation. If two consecutive fields, together forming the same line, have the same polarization along this line, the visual effect of double treatment of the junction zone between these two fields tends to be much less marked than if the two fields have different polarizations, with a difference in polarization angle preferably greater than or equal to 20° and less than or equal to 90°. Also, having polarizations that definitely differ sufficiently between two consecutive lines obviates the directionality of observation of the iridescent effect. The combination of these phenomena makes the iridescent effect of the treated sheet appear much more uniform, in all viewing directions than is the case where there is not this alternation of polarization between contiguous lines.

Where the treatment is performed “in lines”, with a distance separating the centers of the pulses slightly that is slightly smaller than the diameter of the pulse in the direction of fast scanning, to ensure that there are no zones not treated by the pulse, the solution according to the invention is to alternate lines for which wavelet orientation is modified from one line to another, via the action of a polarizer or any other type of polarizing optical device positioned on the optical pathway of the beam.

Therefore, either the treatment field is obtained with an automatic system allowing modification of the polarization of the incident beam between each line, or the treatment field is obtained in a number of times M equal to at least two, and preferably to at least three, M thus corresponding to the number of different orientations imparted to the wavelets by the periodically consecutive polarizations of the laser beam pulse forming these wavelets.

The principle of the invention is also valid when the treatment is carried out “by points” according to a matrix. Each point corresponding to a pulse impact has a different wavelet orientation than its neighbors. In two contiguous optical fields, points are generated according to matrices that extend each other.

FIG. 2 shows a typical architecture of a part of a unit device allowing implementation of the method of the invention, to treat at least part of a stainless steel sheet 1 on a given field. Of course, this device is controlled by automated means, allowing synchronization of the relative movements of the support 13 of the sheet 1 and of the laser beam 7, as well as to adjustment of the parameters of the laser beam 7 and its polarization, as required.

The device first comprises a laser source 6 of a type conventionally known to obtain iridescent effects on metal surfaces, therefore typically a source 6 generating a pulsed laser beam 7 of short pulse duration (less than one nanosecond), the diameter of each pulse typically being of the order of 30 to 40 μm, for example, as seen previously. The energy injected on the surface of the stainless steel by the pulse is to be determined experimentally, so as to generate LIPPS wavelets on the surface of the sheet 1, preferably of the LSFL type, and to prevent the formation of bumps, even more so of spikes, and the frequency and power of the laser beam 7 must be chosen accordingly, following criteria known for this purpose to those skilled in the art and having regard to the precise characteristics of the other elements of the device and of the material to be treated. The laser beam 7 generated by the source 6 then passes through an optical beam shaping system 8, which, in addition to its conventional components 9 allowing adjustment of the shape and dimensions of the beam 7, includes, according to the invention, a polarizing optical element 10 which makes it possible to confer a polarization, chosen by the operator or automations that manage the device, on the beam 7.

The laser beam 7 then passes through a scanning device (e.g. a scanner) 11 which, as is known, enables the beam 7 to scan the surface of the sheet 1 along a rectilinear path in a treatment field. At the output of the scanner 11, again as is conventional, there is a focusing system 12, such as a focusing lens, by means of which the laser beam 7 is focused in the direction of the sheet 1.

In the example shown, the sheet 1 is carried by a mobile support 13, allowing movement of the sheet along a plane or optionally in the three spatial dimensions relative to the device generating, polarizing and scanning the laser beam 7, so that the latter is able to process the surface of the sheet 1 along a new line of the treatment field of the illustrated device. But before this treatment of said new line, according to the invention, the optical polarization device 10 of the laser beam 7 has had its setting modified, so as to impart polarization to the laser beam 7 that differs from its previous polarization when treating the preceding line.

At least two different angles of polarization and preferably at least three are able to be obtained with the polarization optical device 10, and are alternated, preferably but not necessarily, periodically at each line change. Periodicity of the polarization pattern is not essential; it is sufficient, as mentioned, that the polarization angles of two adjacent lines 14, 15, 16 are different, preferably by at least 20° and at most 90°. However, periodicity of the pattern, for example as illustrated with polarization angles that are repeated every three lines 14, 15, 16, is preferred insofar as periodic programming of polarization change is simpler than random programming, in particular since two lines 14, 15, 16 belonging to two different fields and lying in the continuation of each other must have the same wavelet orientation.

A succession of random polarizations within a given optical field, preferably respecting the aforementioned minimum angular difference of 20° and the aforementioned maximum angular difference of 90°, would be acceptable, in particular if the facility were to be used to process relatively narrow sheets would only require a single field for this purpose and for which the question of polarization identity on two lines located in the extension of each other and generated in two contiguous fields does not arise.

The whole device for treatment the sheet 1 most typically comprises a plurality of unit devices such as just described, placed facing the sheet 1, and which are juxtaposed so that their respective treatment fields, i.e., the optical fields of the focusing systems 12 of the scanners 11, overlap slightly. This overlapping is typically about twice the size of the pulse, plus positional uncertainty related to the pulse feed period of the laser and the scanning speed of the laser along the fast axis. It must be verified experimentally that this overlap is sufficient to ensure that no untreated areas remain on the sheet at the end of the operation. Additionally, the lines generated by each of these fields must be in continuity with each other, and the settings of the unit devices must be identical, particularly in terms of shape, size, power and angle of polarization at an instant t of their respective laser beams 7, so that treatment is homogeneous over an entire line having the width of the sheet 1, and so that the alternation of the polarization angles of the laser beam 7 between two consecutive lines is identical over the whole width of the sheet.

The means controlling these unit devices are most typically means common to all the unit devices so that they operate in perfect synchronization with each other. They also control the movements of the support 13 of the sheet 1.

Of course, the mobile support 13 could be replaced by a fixed support, and the relative travel of the sheet 1 and the unit treatment devices could be ensured by placing them on a mobile support. Both variants could also be combined, in that the device of the invention would comprise both a mobile support 13 for the sheet 1 and another mobile support for the unit treatment devices, either one of the two possibly being actuated or both simultaneously by the control device as desired by the user.

The number M thus corresponds to the number of different orientations that one wants to give to the wavelets by ensuring a line spacing M times larger than conventional treatment and by offsetting the lines by conventional spacing between each field implementation. FIG. 3 shows an example of the effect of said creation with M=3.

The sheet 1 on its surface exhibits a periodic succession of lines 14, 15, 16 formed by two devices of the invention which allowed the creation of this periodic pattern of three kinds of lines 14, 15, 16 on two contiguous optical fields 17, 18, the lines 14, 15, 16 of a given field lying in the continuation of lines 14, 15, 16 of the contiguous optical field.

The lines 14, 15, 16 in the pattern differ from each other by the effects of the different polarizations that the polarization device 10 applied to the laser beam 7 at the time of their formation.

As can be seen in the portion of FIG. 3 illustrating a magnified fraction of the surface, in the illustrated, nonlimiting example, the polarization imparted to the laser during generation of the first line 14 of the pattern leads to an orientation of the wavelets in the direction perpendicular to the relative direction of travel 6 of the sheet 1 in relation to the laser treatment device. Then, to generate the second line 15 of the pattern, the polarization of the laser beam 7 has been modified to obtain orientation of the wavelets at 45° from the orientation of the wavelets of the first line 14. Finally, to generate the third line 16 of the pattern, the polarization of the laser beam 7 was modified so as to obtain an orientation of the wavelets at 45° of the orientation of the wavelets of the second line 15, hence at 90° of the orientation of the wavelets of the first line 14: the wavelets of the third line 16 are thus oriented parallel to the relative direction of movement 6 of the sheet 1 in relation to the laser treatment device.

In the junction zone of two contiguous fields, more energy is injected onto the surface of the sheet 1 than is injected onto the rest of the surface, just as in the prior art previously described. However, the fact that in this junction zone the lines 14, 15, 16 of each optical field that meet were produced with the same polarization of the laser beam 7 clearly attenuates deterioration of the visual iridescent effect of the surface which would be encountered if there were no controlled polarization of the laser beam 7. Lack of continuity of the orientation of the wavelets from one optical field to another would tend to increase the visibility of the junction zone of the fields on a given line 14, 15, 16, creating an area of heterogeneity on the surface. Care must simply be taken to ensure that the lines 14, 15, 16 of the two contiguous fields made with identical polarizations are in line with each other, but this precaution about the co-linearity of the lines 14, 15, 16 of contiguous fields was also to be taken in implementing methods of the prior art (see FIG. 1), and the equipment known for this purpose can be used in this variant of the invention. It only needs be ensured that the polarization changes of the laser beams 7 of the devices relating to each field are carried out with the same values for the joining lines of the fields.

The use of M=2 orientations of different polarizations offset for example by 90°, is already sufficient to obtain a visible iridescent effect along most viewing directions. However, the intensity of the iridescent effect still varies fairly substantially when viewing at an angle of 45°, and it can be considered that the problem of lack of directionality of the iridescent effect is still not solved in fully satisfactory manner. This is no longer visible as soon as M is higher than 2, preferably if the angles differ by more than 20° between two consecutive lines 14, 15, 16.

Therefore, by performing treatment with at least three different angles of polarization distributed between 0 and 90° and preferably having polarization differences of at least 20° between two consecutive lines 14, 15, 16, experience has shown that the iridescent effect of the surface is visible in all directions with similar intensity. It is possible to use a number of orientations M higher than 3, but care must then be taken to ensure that the polarization angles of two contiguous lines differ sufficiently from each other to avoid directionality of the desired iridescent effect.

The same condition of a polarization difference of at least 20° between two contiguous points should preferably be respected in the case of a point treatment.

It is evident, however, that the surface structure distribution in different orientations induces a decrease in the total intensity of the iridescent effect when compared with a surface treated in a single polarization direction and viewed at an optimal angle (transverse angle to the structure). A trade-off must therefore be found between the intensity of the visual iridescent effect perceived by an observer and the omnidirectional nature of this iridescent effect. However, three polarization directions (hence a periodicity of three lines of these directions, as illustrated in FIG. 3) already represent said good trade-off, at least in most cases.

Where the scanner allows treatment “in points”, according to a matrix, the wavelet orientation can be modified between the different points of a line and/or between consecutive lines. However, it remains important that each point is formed only by the accumulation of irradiations sharing the same polarization, if the energy injected to form a given point must be injected by means of several passes of the laser beam 7. This can be achieved by changing the polarization of the irradiating beam between each point or by making M arrays of points, with M equal to at least 2 and preferably at least 3, each having a different wavelet orientation, in other words each having been made with a different polarization of the laser beam 7.

One could think of making differences in wavelet orientations not by optical means (the polarizer 10), but by mechanical means, by making modifications of the relative orientations of the support 13 of the sheet 1 and of the support of the laser scanner devices, typically by making the support 13 rotate by an angle equal to the desired difference in orientation for wavelets of a given line 14, 15, 16 in relation to that of the line 14, 15, 16 previously made. But this solution would not be ideal. Indeed, the precise creation of the wavelets would depend on possible polarization irregularities of the laser beam 7, and to rotate the support 13 with the necessary speed and angular precision would pose complex mechanical problems, in particular in the case of an industrial facility intended to treat heavy and large objects. The use and control of a polarizer 10 is generally simpler to implement.

Finally, to obtain the most homogeneous effect possible, it is recommended to alternate the orientations, preferably periodically, over the shortest possible distances. In the case of lines, it is preferable to periodically alternate a single line of each orientation, with a width equal to or preferably slightly less than the diameter of the pulse (to ensure treatment of the entire surface of the sheet). In the case of spot treatment, it is preferable to periodically alternate the orientations on a square or rectangular pattern containing a number of spots equal to the number of different orientations possible for the polarization of the laser beams 7.

Of course, it would still be in the spirit of the invention to apply this method to a sheet whose relatively small width would require only one scanner to perform the structuring of its entire surface into lines of different polarizations in a periodic pattern. The main advantage of the invention is that the intensity of the iridescent effect does not depend on the angle the sheet is observed. If one only wants to treat such narrow sheets, one can then afford to do so with a facility that would include only one device according to FIG. 2.

It is also possible, on the same facility, to process both sheets of a relatively small width, less than or equal to that of a treatment field of a device according to FIG. 2, and sheets of larger width requiring the juxtaposition of several devices according to FIG. 2, each acting on a single treatment field. For this purpose, it is sufficient to activate only one of these devices when treating a narrow sheet. The fact that the method of the invention can be used for multiple sheet widths, with the same settings for each field taken individually, makes it possible to obtain sheets of identical effect irrespective of said width, and thus to homogenize the effect of the range of products of various widths that the manufacturer may wish to produce.

It is possible to process sheets 1 not having perfect planarity by including means in the treatment device to measure the distance between the focusing system 12 and the sheet 1, and by coupling these with the means for controlling the focusing system 12, so that the latter can guarantee that the diameter of the pulse and the fluence of the laser beam are substantially the same irrespective of the effective distance between the focusing system 12 and the sheet 1. The distance between the focusing system and the surface of the metal sheet 1 is also a parameter that can be influenced, if it can be adjusted in real time by appropriate mechanical means.

It is also possible to envisage the application of the method to materials other than planar metal sheets (for example to formed sheets, bars, tubes, parts generally comprising three-dimensional surfaces), by accordingly adapting the means for relative movement of the lasers and part to be treated, and/or the controls of the focusing means if differences in distance between the laser emitter and the surface are to be managed. For parts having substantially cylindrical surfaces (bars, tubes of circular section for example), one manner of proceeding would be to place the laser devices on a fixed support and to provide a support for the part allowing the part to be placed in rotation so that the surface of the part travels in the optical fields of the lasers.

Finally, it is recalled that while stainless steels are materials to which the invention is preferentially applicable, other metal and nonmetal materials on which an iridescent effect can be obtained on the surface thereof by laser treatment are also concerned by the invention.

1. A method for creating an iridescence visual effect on the surface of a part, whereby a laser beam having a pulse duration of less than one nanosecond is sent onto said surface in the optical field of the focusing system of a device comprising a laser source a scanner and said focusing system, so as to apply a structure in the form of wavelets having the same orientation to said surface over the width of said pulse, and said scanner scans said surface with said laser radiation along a series of consecutive lines, or a matrix of points, the width of each line or the dimension of each point of each matrix being equal to the diameter of said pulse, by means of relative travel of said surface and device emitting said laser beam, wherein between the carrying out of the scanning along two consecutive lines or two adjacent points, the polarization of the laser beam is modified so as to create wavelets of different orientations on two consecutive lines or two adjacent points.

2. The method according to claim 1, wherein the polarization of the laser beam is modified according to a periodic pattern, said periodic pattern extending over M consecutive lines, M being equal to at least 2.

3. The method according to claim 1, character wherein two consecutive lines or two adjacent points have angles of polarization differing by at least 20° and at most 90°.

4. The method according to one of claim 1, wherein a laser beam, with a pulse duration of less than one nanosecond, is sent onto said surface in the optical field of the focusing system of a first device comprising a laser source, a scanner and said focusing system, in that a laser beam with a pulse duration of less than one nanosecond is sent onto said surface in the optical field of the focusing system of at least one second device comprising a laser source, a scanner and said focusing system, with the polarizations of two lines located in the extension of each other or of two adjacent points belonging to two adjacent fields being identical.

5. The method according to claim 1, wherein said relative travel of said surface of said part and of the device(s) emitting said laser beam(s) is carried out by placing said part on a mobile support.

6. The method according to claim 1, wherein said relative movement of said surface of said part and of the device(s) emitting said laser beam(s) is carried out by placing the device(s) emitting said laser beam(s) on a mobile support.

7. The method according to one of claim 1, wherein said part is a sheet metal.

8. The method according to one of claim 1, wherein said surface of said part is three-dimensional

9. The method according to one of claim 1, wherein said part is a stainless steel.

10. An unit device for imparting an iridescent effect to the surface of a part through the formation of wavelets on said surface by the pulse of a laser beam, comprising a laser source generating a laser beam of pulse duration of less than 1 ns, an optical system shaping the beam, a scanner which enabling pulse of the beam, after it has passed through a focusing system, to scan an optical field on the surface of the part in the form of lines or a matrix of points, and means for creating relative movement between said device and said part so as to carry out the treatment on at least part of the surface of said part, wherein said optical system comprises an optical polarizing system imparting determined polarization on said beam, and means for varying this polarization so that, on said surface, two lines or two contiguous points are produced with pulses of different polarizations.

11. The unit device according to claim 10, wherein said device allows the forming of two contiguous points with pulses whose polarizations differ by at least 20° and at most 90°.

12. The unit device according to claim 10, wherein it comprises means for measuring the distance between the focusing system and the surface of the part connected to means for controlling the focusing system and/or the distance between the focusing system and the surface of the part in order to maintain a constant pulse diameter and fluence on said surface, irrespective of said distance.

13. A device for imparting an iridescent effect on the surface of a part by the formation of wavelets on said surface by a laser beam pulse, wherein it comprises at least two unit devices according to claim 10, whose optical fields of the focusing systems overlap.

14. The device according to claim 10, wherein said means for creating a relative movement between said device and said part comprise a mobile support for the part.

15. The device according to one of claim 10, wherein said means for creating a relative movement between said device and said part comprise a mobile support for the unit device(s).

16. A part made of a material whose surface has an iridescent effect by means of a laser treatment, said treatment having formed wavelets on the surface of said part, wherein said wavelets have at least two orientations, distributed over the surface of said part.
